(19) United States
(12) Patent Application Publication
(10) Pub. No.: US 2017/0207440 A1
(43) Pub. Date: Jul. 20, 2017

(54) ALL-SOLID-STATE BATTERY

(71) Applicant: Toyota Jidosha Kabushiki Kaisha, Toyota-shi Aichi-ken (JP)

(72) Inventors: Shigenori Hama, Shizuoka-ken (JP); Hideyo Ebisuzaki, Toyota-shi (JP); Yasumasa Oguma, Setagaya-ku (JP); Satoshi Wakasugi, Gotenba-shi (JP)

(21) Appl. No.: 15/397,272

(22) Filed: Jan. 3, 2017

(30) Foreign Application Priority Data
Jan. 18, 2016 (JP) 2016-007346

(51) Int. Cl. H01M 2/34; H01M 10/0525; H01M 10/0585

(52) U.S. Cl. CPC H01M 2/348; H01M 10/0585; H01M 10/0525; H01M 2200/106

(57) ABSTRACT

Provided is an all-solid-state battery in which the battery reaction can stop when a short circuit occurs. The all-solid-sate battery includes: a cathode layer including a cathode active material layer and a cathode current collector; an anode layer including an anode active material layer and an anode current collector; and a solid electrolyte layer arranged between the cathode active material layer and the anode active material layer, wherein a PTC film is provided: between the cathode current collector and the cathode active material layer; or between the anode current collector and the anode active material layer: or between the cathode current collector and the cathode active material layer and between the anode current collector and the anode active material layer, and the PTC film includes a conductive material and a resin.

### TECHNICAL FIELD

The present disclosure relates to all-solid-state batteries.

### BACKGROUND

Metal ion secondary batteries provided with a solid electrolyte layer including a solid electrolyte (e.g. lithium ion secondary battery. Hereinafter it may be referred to as “all-solid-state battery”) have advantages, for example the system for securing safety is easily simplified.

As a technique related to such all-solid-state batteries, for example Patent Literature 1 discloses a solid battery in which a PTC (Positive Temperature Coefficient) element is connected between at least one of a positive terminal and a negative terminal of a battery and an electrode to be connected to the terminal, in a battery jar. Patent Literature 2 discloses a non-aqueous secondary battery in which a current collector of a cathode and/or anode is coated with a conductive layer including a crystalline thermoplastic resin having a function of a positive temperature coefficient resistor that increases its resistance value with the temperature increase, a conductive material, and a binder, and the thickness of the conductive layer is in the range of from 0.1 μm to 5.0 μm. Patent Literature 3 discloses a battery wherein at least one of active material layers arranged both sides of a separator includes a material having a reaction cutoff function or a current cutoff function at 90-160° C. Patent Literature 3 describes that a solid electrolyte film may be used as the separator. Patent Literature 4 discloses a method for manufacturing a non-aqueous secondary battery including producing an electrode with conductive layer including an electrode mixture including an electrode active material, a current collector that keeps the electrode mixture, and a conductive layer arranged between the current collector and the electrode mixture, and forming a non-aqueous secondary battery using the electrode with conductive layer as at least one of a cathode and an anode.

### CITATION LIST

### Patent Literatures

Patent Literature 1: JP H11-144704 A

Patent Literature 2: JP 2001-357854 A

Patent Literature 3: JP 2004-327183 A

Patent Literature 4: JP 2012-104422 A

### SUMMARY

### Technical Problem

In the technique disclosed in Patent Literature 1, a PTC element is arranged between the terminal and the current collector. It is considered that it gets possible to safely stop the battery reaction by arranging a PTC element at such a position, when a short circuit occurs via the conductive material arranged outside the battery (outer short circuit). However, with this technique, the effect to safely stop the battery reaction cannot be exerted when a short circuit occurs by the contact of the cathode current collector with the anode current collector in the battery (hereinafter referred to as “internal short circuit”). In the conductive layer containing polyethylene produced by the method disclosed in Patent Literature 2, it is difficult to uniformly disperse the polyethylene. Therefore, in the conductive layer, a point where the resistance easily increases and the point where the resistance is difficult to increase are easily mixed. If the point where the resistance is difficult to increase exists in the conductive layer, electric conduction is made via the point. Thus, with the technique disclosed in Patent Literature 2, there is a problem that it is difficult to obtain the effect to stop the battery reaction when the temperature increases. These problems are difficult to be solved even though the techniques disclosed in Patent Literatures 1 to 4 are combined.

An object of the present disclosure is to provide an all-solid-state battery in which the battery reaction can stop when an internal short circuit occurs.

### Solution to Problem

In order to reduce the resistance, a restrictive pressure is applied to an all-solid-state battery in the direction to tightly adhere each layer stacked together. Meanwhile, the PTC element disclosed in Patent Literature 1 and the like have a high resistance at a predetermined temperature, because of the resin melted and expanded, which cuts the electron conductive path in the PTC element. If the PTC element is arranged under the environment where a restrictive pressure is applied, the expansion of the resin might be insufficient. Thus, conventionally, it is considered that the arrangement of PTC element under the environment where a restrictive pressure is applied is difficult, and when a PTC element is used in an all-solid-state battery, the PTC element is arranged at a point where a restrictive pressure is not applied, as disclosed in Patent Literature 1.

The inventors of the present disclosure found, as a result of intensive studies, that it is possible to make the PTC element have a high resistance even when the PTC element is arranged at a point where a restrictive pressure is applied. They also found that it is possible to easily make the PTC have a high resistance by making the restrictive pressure have a predetermined value or less, when the PTC element is arranged at a point where the restrictive pressure is applied. The present disclosure has been completed based on the above findings.

In order to solve the above problem, the present disclosure is directed to the following embodiments. That is, the preset disclosure is an all-solid-state battery including: a cathode layer including a cathode active material layer and a cathode current collector; an anode layer including an anode active material layer and an anode current collector; and a solid electrolyte layer arranged between the cathode active material layer and the anode active material layer, wherein a PTC film is provided: between the cathode current collector and the cathode active material layer; or between the anode current collector and the anode active material layer; or between the cathode current collector and the cathode active material layer and between the anode current collector and the anode active material layer, and the PTC film includes a conductive material and a resin.

Here, in the present disclosure, the resin included in the PTC film is a resin that melts at a temperature higher than 100° C. (for example, no less than 150° C. Hereinafter the same is applied). It is possible to make the PTC film have a high resistance at a high temperature, even when the PTC film is arranged between the current collector and the active material layer of the all-solid-battery, which is a point where a restrictive pressure is to be applied. In addition, by arranging the PTC film between the current collector and the active material layer (surface of the current collector), it is possible to inhibit internal short circuit that occurs due to the contact of the cathode current collector and the anode current collector. Further, when the temperature gets high because of the occurrence of an internal short circuit, the resistance of the PTC film increases, therefore it gets possible to stop the battery reaction. That is, by having the above configuration, it is possible to provide an all-solid-state battery in which the battery reaction can stop when an internal short circuit occurs.

In the present disclosure, a restrictive pressure may be added in a direction to make the cathode current collector and the anode current collector get close to each other, and the restrictive pressure may be no more than 40 MPa.

By making the restrictive pressure no more than 40 MPa, it gets easy to make the PCT film have a high resistance at a high temperature. This makes it possible to easily stop the battery reaction when an internal short circuit occurs.

In the present disclosure wherein the restrictive pressure is no more than 40 MPa, the restrictive pressure may be no less than 0.8 MPa

By making the restrictive pressure no less than 0.8 MPa, it gets easy to inhibit the increase of the resistance, therefore it gets easy to secure the battery performance.

In the above-described present disclosure, the resin may be a thermoplastic resin that melts at a temperature higher than 100° C.

According to the present disclosure, it is possible to provide an all-solid-state battery in which the battery reaction can stop when an internal short circuit occurs.

### BRIEF DESCRIPTION OF DRAWINGS

FIG. 1 is a view to explain an all-solid-state battery of the present disclosure;

FIG. 2 is a view to explain a relationship between the restrictive pressure and DC resistance;

FIG. 3 is a view to explain a relationship between temperature and resistance;

FIG. 4 is a view to explain a relationship between temperature and resistance; and

FIG. 5 is a view to explain a relationship between the restrictive pressure and resistance when the battery is heated.

### DESCRIPTION OF EMBODIMENTS

Hereinafter the present disclosure will be explained with reference to the drawings. It is noted that the embodiments shown below are examples of the present disclosure, and the present disclosure is not limited to the embodiments.

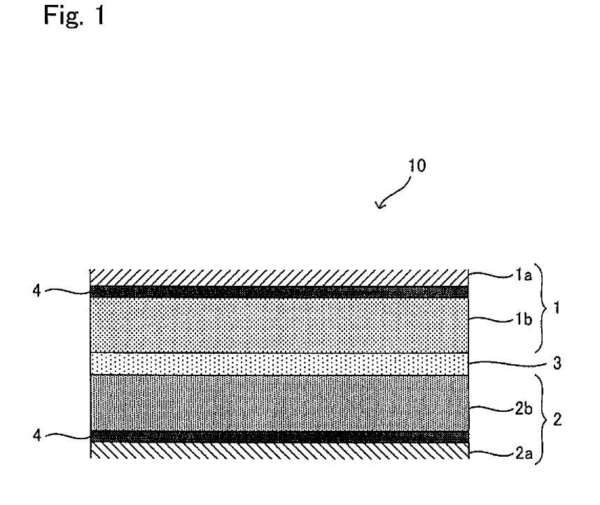

FIG. 1 is a view to explain an all-solid-state battery 10 of the present disclosure. FIG. 1 shows only the portion from a cathode current collector to an anode current collector provided to the all-solid-state battery 10.

The all-solid-state battery 10 shown in FIG. 1 includes: a cathode layer 1 including a cathode active material layer 1b and a cathode current collector 1a; an anode layer 2 including an anode active material layer 2b and an anode current collector 2a; and a solid electrolyte layer 3 arranged between the cathode active material layer 1b and the anode active material layer 2b, wherein a PTC film 4 is arranged between the cathode active material layer 1b and the cathode current collector 1a, and between the anode active material layer 2b and the anode current collector 2a. To the all-solid-state battery 10, a restrictive pressure of no more than 40 MPa is applied in the direction to increase the adhesion of each layer having contact with each other, by means of a restrictive pressure imparting means which is not shown.

For example, if a nail that is stuck from the cathode layer 1 side penetrates the all-solid-state battery 10, the cathode current collector 1a dragged and modified by the nail has contact to the anode current collector 2a, whereby an internal short circuit occurs and a heat is generated. In a conventional all-solid-state battery in which the PTC film 4 is not arranged to the surface of the cathode current collector 1a (between the cathode current collector 1a and the cathode active material layer 1b) or the surface of the anode current collector 2a (between the anode current collector 2a and the anode active material layer 2b), the energizing state of the cathode current collector 1a and the anode current collector 2a is kept even though a heat is generated due to an internal short circuit. Thus, in a conventional all-solid-state battery, the battery reaction may continue even after a nail got stuck thereto. Meanwhile, in the all-solid-state battery 10 provided with the PTC film 4 at a portion where a restrictive pressure is applied as well, an internal short circuit might occur immediately after a nail gets stuck thereto. When the temperature of the PTC film 4 gets high by the heat generation caused by the internal short circuit, the resin included in the PTC film 4 melts and expands, and the expanded resin cuts the electron conductive path between the conductive materials included in the PTC film 4. The PTC film 4 can increases its resistance at a high temperature, even though arranged at a portion where a restrictive pressure is applied. Thus, it is possible to inhibit the transfer of electrons between the cathode current collector 1a and the anode current collector 2a, by the PTC film 4 whose resistance is increased at a high temperature. Because of this, according to the all-solid-state battery 10, it is possible to stop the battery reaction after an internal short circuit occurs. That is, according to the present disclosure, it is possible to provide the all-solid-state battery 10 in which the battery reaction can stop after an internal short circuit occurs. By making the battery reaction stop after an internal short circuit occurs, the safety of the all-solid-state battery 10 can be increased.

In the above explanation, the all-solid-state battery 10 including the PTC film 4 between the cathode current collector 1a and the cathode active material layer 1b and between the anode current collector 2a and the anode active material layer 2b is shown as an example. However, the all-solid-state battery of the present disclosure is not limited to this configuration. In the present disclosure, the PTC film may be provided only between the cathode current collector and the cathode active material layer, or may be provided only between the anode current collector and the anode active material layer. By arranging the PTC film between the current collector and the active material layer, it is possible to make a state in which electrons are difficult to transfer because of the PTC film, whose resistance is increased when the temperature is high after an internal short circuit occurs due to the contact of the cathode current collector and the anode current collector. Therefore, even though the PTC film is provided only between the cathode current collector and the cathode active material layer, or only between the anode current collector and the anode active material layer, it is possible to provide an all-solid-state battery in which the battery reaction can stop when an internal short circuit occurs.

In the above explanation, a configuration in which the restrictive pressure applied is no more than 40 MPa is shown as an example. However, the all-solid-state battery of the present disclosure is not limited to this configuration. However, in view of making a configuration in which the above effect is easily provided by making it easy to increase the resistance of the PTC film at a high temperature, the restrictive pressure may be no more than 40 MPa.

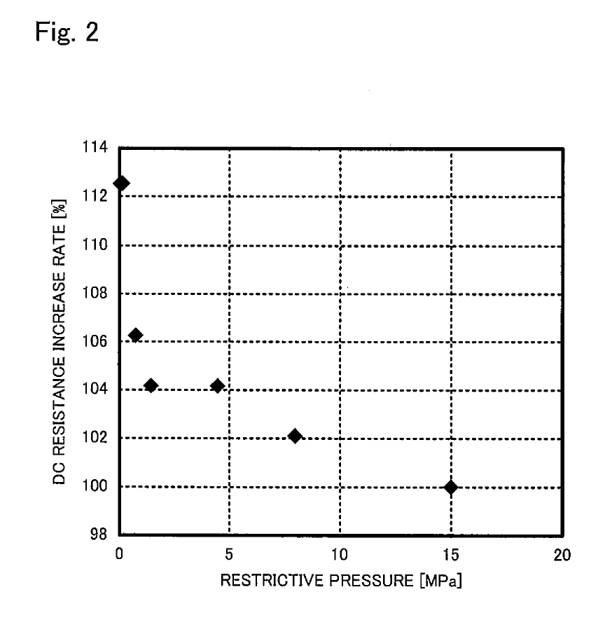

Meanwhile, the performance of the all-solid-state battery might change according to the value of the restrictive pressure. By carrying out an analysis on each resistance component of the all-solid-state battery, it is figured out that the DC resistance component caused by short-time reactions (resistance component on the high-frequency side obtained by DC impedance measurement) is affected greatly from the restrictive pressure. Thus, the lower limit value of the restrictive pressure in the present invention may be determined by the change of the DC resistance component. An all-solid-state battery was manufactured. The battery characteristic and internal resistance were measured while the restrictive pressure was changed, to examine the relationship between the restrictive pressure and the DC resistance. The results are shown in Table 1 and FIG. 2. The restrictive pressure [MPa] applied to the all-solid-state battery is taken along the horizontal axis, and the DC resistance increase rate [%] setting the DC resistance value when the restrictive pressure was 15 MPa as 100% is taken along the vertical axis.

TABLE 1

| Restrictive pressure [MPa] | DC resistance increase rate [%] |
|---|---|
| 0.08 | 113 |
| 0.2 | 113 |
| 0.8 | 106 |
| 1.5 | 104 |
| 4.5 | 104 |
| 8 | 102 |
| 15 | 100 |

As shown in Table 1 and FIG. 2, when the restrictive pressure was in the range of from 0.8 MPa to 8 MPa, the increase rate of the DC resistance was less than 7%, compared to the case where the restrictive pressure was 15 MPa. Meanwhile, when the restrictive pressure was decreased to 0.2 MPa or 0.08 MPa, the DC resistance rapidly increased, compared to the case where the restrictive pressure was 15 MPa. Thus, in view of making an all-solid-state battery in which the battery performance is easily secured, the restrictive pressure may be no less than 0.8 MPa. Thus, in the present disclosure, the restrictive pressure may be in the range of from 0.8 MPa to 40 MPa.

As described above, the PTC film 4 includes a conductive material and a resin. The conductive material for the PTC film 4 is not particularly limited, as long as the conductive material can be used for PTC elements and can endure the use environment of the all-solid-state battery 10. Examples of such a conductive material include carbon materials such as furnace black, Ketjen black and acetylene black, metal such as silver, conductive ceramics such as titanium carbide. The shape of the conductive material used for the PTC film 4 is not particularly limited, and for example it may be in a powder form, in view of easily dispersing the conductive material in the PTC film 4.

The resin used for the PTC film 4 is not particularly limited as long as the resin can be used for PTC elements, can endure the use environment of the all-solid-state battery 10, and melts at a temperature higher than 100° C. Examples of such a resin include polyvinylidene fluoride (hereinafter referred to as “PVDF”), polyethylene (PE) and polypropylene (PP). These resins are thermoplastic resins. Thus, it is considered that, with these resins, in the same way as with the PTC film formed with PVDF which is described later, it is possible to keep a high resistance value at a high temperature under the environment where an electrolyte solution does not exist, and the strength of the resin decreases under the environment where the resins have contact with an electrolyte solution. In addition, among the above resins, a resin whose molecular weight is large may be used, in view of making it easy to inhibit short circuit for a long time, by the PTC film 4 keeping remaining between the current collector and the active material layer under the environment where the restrictive pressure is applied at a high temperature. Examples of such a resin include ultrahigh molecular weight polyethylene and PVDF whose molecular weight shows no less than 1.0×10⁵. As another method, it is also possible to carry out a cross linking treatment to make the resin have a strength at a high temperature.

An example of the production method of the PTC film 4 will be described hereinafter. In forming the PTC film 4, for example a carbon material dispersion solution is prepared by dispersion of carbon materials that are conductive materials, in an organic solvent such as N-methyl-2-pyrolidone (hereinafter referred to as “NMP”). Meanwhile, by dispersing PVDF in NMP, a resin dispersion solution is prepared. Thereafter, the carbon material dispersion solution and the resin dispersion solution are mixed, whereby a composition for conductive layer formation is prepared. The composition is applied to a surface(s) of the current collector (e.g. both surfaces), and dried, whereby the PTC film 4 may be formed. The thickness of the PTC film 4 that can be formed as above may be thin as long as the above-described effect can be provided, in view of making it easy to increase the energy density of the all-solid-state battery 10. In view of making the PTC film 4 whose resistance is easily increased, a heat treatment may be carried out at a temperature of no less than 120° C. and no more than 165° C., after the PTC film is formed on the conductive layer. This makes the resistance at a normal operation (e.g. no more than 100° C.) of the all-solid-state battery low, and makes it easy to increase the resistance after the temperature gets no less than 150° C. by the heat generation due to a short circuit in the all-solid-state battery, therefore, it gets easy to stop the battery reaction. This makes it possible to provide the all-solid-state battery 10 that has a high performance because the resistance of the PTC film 4 is low at a normal operation, and that can increase the safety because the resistance of the PTC film 4 increases only at a high temperature and the battery reaction stops safely.

In this manner, the PTC film 4 may be formed on the both surfaces of the cathode current collector 1a, and the both surfaces of the anode current collector 2a. After the PTC film 4 is produced, the cathode layer 1 is formed by arrangement of the cathode active material layer 1b in a manner to sandwich the PTC film 4 formed on the cathode current collector 1a by the cathode current collector 1a and the cathode active material layer 1b. The anode layer 2 is formed by arrangement of the anode active material layer 2b in a manner to sandwich the PTC film 4 formed on the anode current collector 2a by the anode current collector 2a and the anode active material layer 2b. Thereafter, via a process of stacking the cathode layer 1, the solid electrolyte layer 3, and the anode layer 2, in a manner to arrange the solid electrolyte layer 3 between the cathode active material layer 1b and the anode active material layer 2b, the all-solid-state battery 10 may be produced.

The all-solid-state battery of the present disclosure includes a cathode current collector, a cathode active material layer, a solid electrolyte layer, an anode active material layer, and an anode current collector, in the order mentioned, and the the PTC film only has to be provided between the cathode current collector and the cathode active material layer, and/or between the anode current collector and the anode active material layer. When the all-solid-state battery of the present disclosure has a configuration in which the PTC film is arranged between the cathode current collector and the cathode active material layer, and between the anode current collector and the anode active material layer, examples of the all-solid-state battery of the present disclosure include: a single layer battery (cathode current collector/PTC film/cathode active material layer/solid electrolyte layer/anode active material layer/PTC film/anode current collector); two of single layer batteries in which the active material layer and the solid electrolyte layer are arranged symmetrically at the upper and lower sides of the current collector positioned at the center (cathode current collector/PTC film/cathode active material layer/solid electrolyte layer/anode active material layer/PTC film/anode current collector/PTC film/anode active material layer/solid electrolyte layer/cathode active material layer/PTC film/cathode current collector); and a battery produced by stacking these plurality of batteries.

In the present disclosure, for the cathode active material to be contained in the cathode active material layer 1b, a cathode active material that can be used in all-solid-state batteries may be adequately used. Examples of such a cathode active material include layered active materials such as lithium cobaltate (LiCoO₂) and lithium nickelate (LiNiO₂), olivine type active materials such as olivine type lithium iron phosphate (LiFePO₄), and spinel type active materials such as spinel type lithium manganate (LiMn₂O₄). The shape of the cathode active material may be in a particle form and a thin-film form for example. The content of the cathode active material in the cathode active material layer 1b is not particularly limited, and for example it may be in the range of from 40% to 99% by mass.

In the all-solid-state battery of the present disclosure, not only the solid electrolyte layer 3, but also the cathode active material layer 1b and the anode active material layer 2b may include a solid electrolyte that can be used for all-solid-state batteries, as necessary. Examples of such a solid electrolyte include oxide-based amorphous solid electrolytes such as Li₂O—B₂O₃—P₂O₅ and Li₂O—SiO₂, sulfide-based amorphous solid electrolytes such as Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅ and Li₃PS₄, and crystalline oxides and crystalline oxynitrides such as LiI, Li₃N, Li₅La₃Ta₂O₁₂, Li₇La₃Zr₂O₁₂, Li₆BaLa₂Ta₂O₁₂, Li₃PO_{(4-3/2w)}N_{w} (w<1) and Li_{3.6}Si_{0.6}P_{0.4}O₄. However, in view of making it easy to increase the performance of the all-solid-state battery and the like, a sulfide solid electrolyte may be used for the solid electrolyte.

When a sulfide solid electrolyte is used as the solid electrolyte, the cathode active material may be coated with an ion conductive oxide, in view of making it easy to prevent the increase in the battery resistance by making it difficult to form a high resistance layer at the interface between the cathode active material and the solid electrolyte. Examples of the lithium ion conductive oxide to coat the cathode active material include an oxide represented by the general formula LiₓAO_{y} (A is B, C, Al, Si, P, S, Ti, Zr, Nb, Mo Ta or W, x and y are each a positive number). Specifically, Li₃BO₃, LiBO₂, Li₂CO₃, Li_{A}IO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄ and Li₂WO₄ may be given. The lithium ion conductive oxide may be a complex oxide. As the complex oxide to coat the cathode active material, any combination of the above-described lithium ion conductive oxides may be given. For example, Li₄SiO₄—Li₃BO₃, Li₄SiO₄—Li₃PO₄ and the like may be given. When the surface of the cathode active material is coated with an ion conductive oxide, the ion conductive oxide only have to coat at least part of the cathode active material, and may coat the whole surface of the cathode active material. The thickness of the ion conductive oxide to coat the cathode active material may be for example in the range of from 0.1 nm to 100 nm, and may be in the range of from 1 nm to 20 nm. The thickness of the ion conductive oxide may be measured by means of a transmittance electron microscope (TEM) and the like.

The cathode active material layer 1b may be produced with a binder that can be contained in cathode layers of all-solid-state batteries. Examples of such a binder include acrylonitrile butadiene rubber (ABR), butadiene rubber (BR), polyvinylidene fluoride (PVDF) and styrene butadiene rubber (SBR).

The cathode active material layer 1b may further contain a conductive material that improves the conductivity. Examples of the conductive material that can be contained in the cathode active material layer 1b include carbon materials such as vapor-grown carbon fiber, acetylene black (AB), Ketjen black (KB), carbon nanotube (CNT) and carbon nanofiber (CNF), and metal materials that can endure the use environment of the all-solid-state battery. When the cathode active material layer 1b is produced with a cathode composition in a slurry form adjusted by dispersion of the above cathode active material, solid electrolyte, binder and the like in a liquid, examples of the liquid that can be used include heptane, and a non-polar solvent may be used. The thickness of the cathode active material layer 1b may be for example in the range of from 0.1 μm to 1 mm, and may be in the range of from 1 μm to 100 μm. In order to make it easy to increase the performance of the all-solid-state battery, the cathode active material layer 1b may be produced via a process of pressing. In the present disclosure, the pressure to press the cathode active material layer may be approximately 100 MPa.

As the anode active material to be contained in the anode active material layer 2b, an anode active material that can be used in all-solid-state batteries may be adequately used. Examples of such an anode active material include carbon active materials, oxide active materials and metal active materials. The carbon active materials are not particularly limited as long as they contain carbon, and examples thereof include mesocarbon micro beads (MCMB), highly orientated pyrolytic graphite (HOPG), hard carbon and soft carbon. Examples of the oxide active materials include Nb₂O₅, Li₄Ti₅O₁₂ and SiO. Examples of the metal active materials include In, Al, Si and Sn. In addition, as the anode active material, a lithium-containing metal active material may be used. The lithium-containing metal active material is not particularly limited as long as it contains at least Li, and may be a Li metal, or a Li alloy. Examples of Li alloy include an alloy containing Li and at least one kind from In, Al, Si and Sn. The shape of the anode active material may be in a particle form and in a thin-film form, for example. The content of the anode active material in the anode active material layer 2b is not particularly limited, and for example it may be in the range of from 40% to 99% by mass.

Further, the anode active material layer 2b may contain a binder to bond the anode active material and the solid electrolyte, and a conductive material to improve the conductivity. Examples of the binder and the conductive material that can be contained in the anode active material layer 2b include the above-described binders and conductive materials that can be contained in the cathode active material layer 1b. When the anode active material layer 2b is produced with an anode composition in a slurry form adjusted by dispersion of the above-described anode active material and the like in a liquid, examples of the liquid to disperse the anode active material and the like may include heptane, and a non-polar solvent may be used. The thickness of the anode active material layer 2b may be for example in the range of from 0.1 μm to 1 mm, and may be in the range of from 1 μm to 100 μm. In order to easily improve the performance of the solid battery, the anode active material layer 2b may be produced via a process of pressing. In the present disclosure, the pressure in pressing the anode active material layer may be no less than 200 MPa, and may be approximately 400 MPa.

As the solid electrolyte to be contained in the solid electrolyte layer 3, a solid electrolyte that can be used in all-solid-state batteries may be adequately used. Examples of such a solid electrolyte include the above-described solid electrolytes and the like that can be contained in the cathode active material layer 1b and the anode active material layer 2b. In addition, the solid electrolyte layer 3 may contain a binder to bond the solid electrolytes to each other, in view of providing plasticity and the like. Examples of such a binder include the above-described binders that can be contained in the cathode active material layer 1b. In view of making it possible to form the solid electrolyte layer 3 including a solid electrolyte not excessively aggregated but uniformly dispersed and the like, the content of the binder contained in the solid electrolyte layer 3 may be no more than 5 mass %. When the solid electrolyte layer 3 is produced via a process of applying a solid electrolyte composition in a slurry form adjusted by dispersion of the above-described solid electrolyte and the like in a liquid onto the cathode active material layer 1b, the anode active material layer 2b, and the like, examples of the liquid to disperse the solid electrolyte and the like include heptane, and a non-polar solvent may be used. The content of the solid electrolyte material in the solid electrolyte layer 3 may be for example no less than 60%, may be no less than 70%, and may be no less than 80%, by mass. The thickness of the solid electrolyte layer 3 greatly differs depending on the structure of the battery. The thickness of the solid electrolyte layer 3 may be for example in the range of from 0.1 μm to 1 mm, and may be in the range of from 1 μm to 100 μm.

For the cathode current collector 1a and the anode current collector 2a, metal that can be used as a current collector of all-solid-state batteries may be adequately used. Examples of such metal include a metal material including one or two or more element selected from the group consisting of Cu, Ni, Al, V, Au, Pt, Mg, Fe, Ti, Co, Cr, Zn, Ge and In.

The mixing ratio of the conductive material and the resin contained in the PTC film 4 may be for example conductive material:resin=5:95 to 50:50 by volume. The mixing ratio of the conductive material and the resin may be determined by the resistance value that does not affect the battery performance in normal use and the resistance value at which the progression of the battery reaction can be stably stopped when an abnormal heat is generated. The thickness of the PTC film 4 may be for example in the range of from 0.1 μm to 50 μm.

In the above explanation regarding the present disclosure, materials that can be used for an all-solid-state battery that is a lithium ion secondary battery are mainly shown as examples. However, the all-solid-state battery of the present disclosure is not limited to a lithium ion secondary battery. The all-solid-state battery of the present disclosure may have a configuration in which ions other than lithium ion transfer between the cathode active material layer and the anode active material layer. Examples of such ions include sodium ion and potassium ion. When the battery has a configuration in which ions other than lithium ion transfer, the cathode active material, solid electrolyte and anode active material may be adequately chosen depending on the ion to transfer.

### EXAMPLES

1. Resistance Measurement of Current Collector with PTC Film

### Example

A furnace black (manufactured by TOKAI CARBON CO., LTD.) of 66 nm in average primary particle size, which was a conductive material, and a PVDF (Kureha KF polymer L#9130, manufactured by KUREHA CORPORATION) were weighed so that the conductive material:PVDF=20:80 by volume. They were mixed with NMP (manufactured by NIPPON REFINE Co., Ltd.), whereby a composition for PTC film was produced.

Next, to a surface of an Al foil of 15 μm in thickness, which was a current collector, the above composition for PTC film was applied so that the thickness of PTC film after dried was 10 μm. Thereafter, the obtained material was dried in a stationary drying furnace at 100° C. for 1 hour, whereby a PTC film was formed on the surface of the current collector.

Next, the current collector, on the surface of which the PTC film was formed, was put in a thermostatic bath, and a heat treatment of keeping the current collector at 140° C. for 2 hours was carried out, whereby a current collector with PTC film was produced.

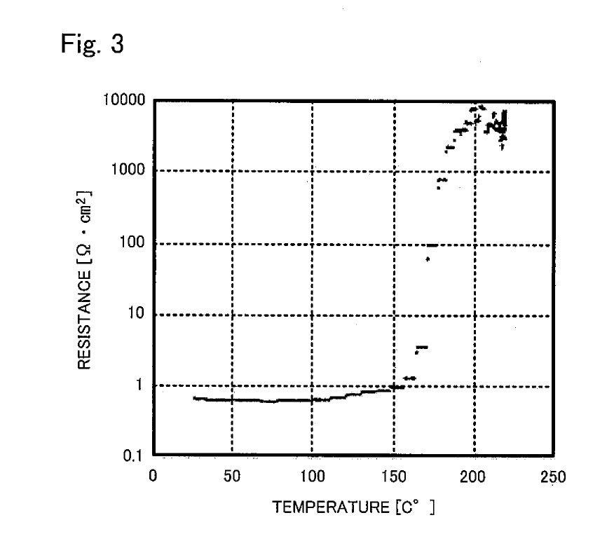

The current collector with PTC film produced as above was cut out into a round shape of 11.28 mm in diameter (area 1 cm²). Thereafter, an Al foil was lapped over the PTC film side of the current collector. The foil and current collector were sandwiched by cylindrical-shaped terminals having the same diameter and fixed in a jig. After that, the jig on which a restrictive pressure of 15 MPa was applied was installed in a thermostatic bath, and the electrical resistance when the temperature was increased at a fixed increase rate was measured. Specifically, 1 mA of constant current conduction was made between the terminals, and the voltage between the terminals when the conduction was made was measured, whereby the resistance value was calculated. The result is shown in FIG. 3. The temperature [° C.] is taken along the horizontal axis and the resistance [Ω·cm²] is taken along the vertical axis in FIG. 3.

### Comparative Example

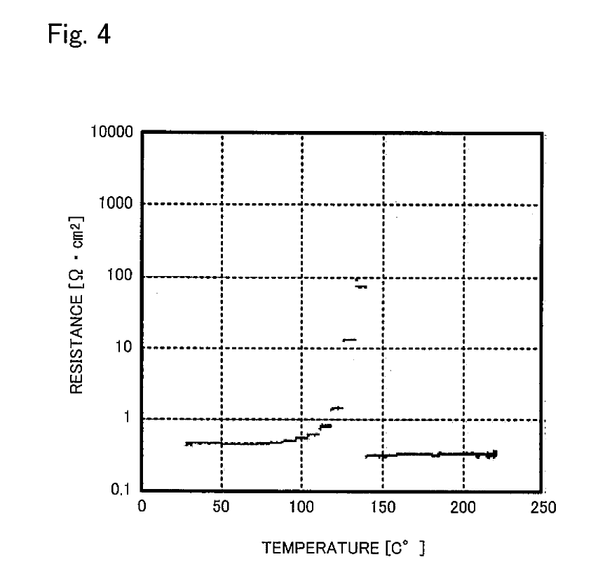

A current collector with PTC film produced in the same way as in Example was immersed in an electrolyte solution produced by mixing ethylene carbonate (EC) and dimethyl carbonate (DMC) to be EC:DMC=30:70, at a room temperature for 12 hours. Thereafter, the current collector with PTC film was cut out into a round shape of 11.28 mm in diameter (area 1 cm²), and an Al foil was lapped over the PTC film side. The obtained material was sandwiched by cylindrical-shaped terminals having the same diameter and fixed in a jig. Thereafter, the electrolyte solution was dropped in the jig. The jig on which a restrictive pressure of 15 MPa was applied was installed in a thermostatic bath, and in the same manner as in Example, the electrical resistance when the temperature was increased at a fixed increase rate was measured. The result is shown in FIG. 4. The temperature [C] is taken along the horizontal axis and the resistance [Ω·cm²] is taken along the vertical axis in FIG. 4.

As shown in FIG. 3, the current collector with PTC film of Example, in which an electrolyte solution was not used, rapidly increased its resistance when the temperature got more than 150° C., and had the maximum value of the resistance at around 200° C. (approximately 9000Ω). After that, the resistance kept a higher value than 1000Ω even though the temperature was increased to 220° C.

In contrast, as shown in FIG. 4, in the current collector with PTC film of Comparative Example in which an electrolyte solution was used, the resistance started to increase from at around 100° C., and had the maximum value at around 130° C. (approximately 90Ω). After that, the resistance rapidly decreased when the temperature was increased to around 140° C., and then kept a low value of less than 1Ω, even though the temperature was increased.

From these results, it was figured out that: when the PTC film was arranged between the current collector and the active material layer of a battery provided with an electrolyte solution, the PTC film was effective as a countermeasure against internal short circuit as long as the temperature increase was small; however, after the temperature was increased to no less than 140° C., the PTC film did not function as a countermeasure against internal short circuit. Thus, it is presumed that it is unlikely for one skilled in the art who knew this result to think of developing a solid battery in which the PTC film is arranged between the current collector and the active material layer. In contrast, as shown in FIG. 3, the inventors of the present disclosure examined the relationship between the temperature and the resistance under the environment that a restrictive pressure was applied in the same manner as in an all-solid-state battery, without using an electrolyte solution. As a result, it was figured out that: in an environment where an electrolyte solution was not used, the resistance of the PTC film kept increasing even after the temperature got 140° C. or more, and the maximum value of the resistance was approximately 100 times as large as the maximum value when an electrolyte solution was used. It was further found that the PTC film kept a high resistance at 220° C. under the environment where an electrolyte solution was not used.

They presume that: when an electrolyte solution was used, the following was the reason for the insufficient resistance increase of the PTC film and the rapid decrease of the resistance at around 140° C. That is, it is considered that: by the expansion of the PTC film having contact with the electrolyte solution, the strength of the resin included in the PTC film degraded, and the resin could not endure the restrictive pressure of 15 MPa any longer; as a result, it got easy for electrons to conduct between the conductive materials included in the PTC film.

In contrast, it is considered that: when an electrolyte solution was not used, the reason for the great increase in the resistance of the PTC film and the high resistance kept even at 220° C. was that the strength of the PTC film that did not have contact with an electrolyte solution did not degrade, and it was possible to keep the state that the electron conductive path between the conductive materials included in the PTC film was cut.

It is considered that the all-solid-state battery of the present disclosure in which the PTC film is arranged between the current collector and the active material layer which is a point where a restrictive pressure is applied, may have approximately 100 times as high resistance value at a high temperature, as the resistance of a battery provided with an electrolyte solution in which the PTC film is arranged between the current collector and the active material layer. Thus, according to the present disclosure, it is possible to stop the battery reaction even when an internal short circuit occurs. In addition, the PTC film to be provided to the all-solid-state battery of the present disclosure can keep a high resistance under a high temperature environment. Thus, according to the present disclosure, it is possible to stop the battery reaction for a long time, even when an internal short circuit occurs.

### 2. Relationship Between Restrictive Pressure and Resistance

A furnace black (manufactured by TOKAI CARBON CO., LTD.) of 66 nm in average primary particle size, which was a conductive material, and a PVDF (Kureha KF polymer L#9130, manufactured by KUREHA CORPORATION) were weighed so that the conductive material:PVDF=20:80 by volume. They were mixed with NMP (manufactured by NIPPON REFINE Co., Ltd.), whereby a composition for PTC film was produced.

Next, to a surface of an Al film of 15 μm in thickness, which was a current collector, the above composition for PTC film was applied so that the thickness of PTC film after dried was 10 μm. Thereafter, the obtained material was dried in a stationary drying furnace at 100° C. for 1 hour, whereby the PTC film was formed on the surface of the current collector.

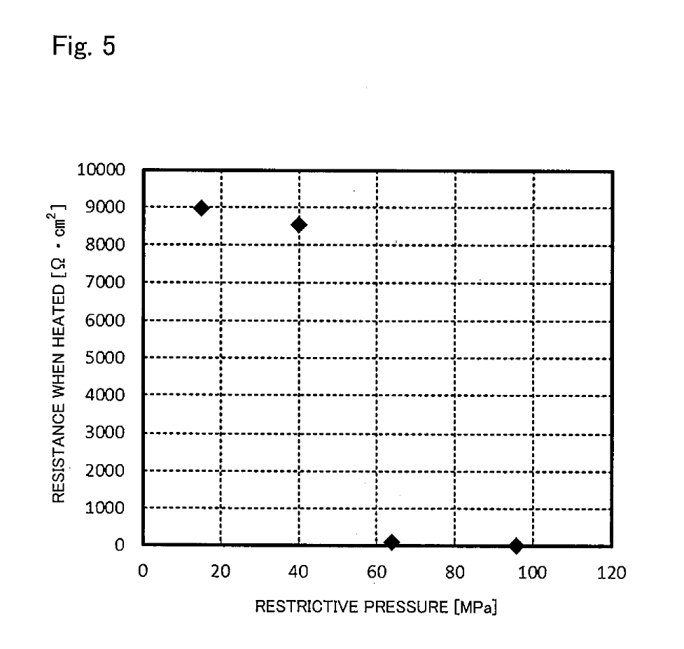

The current collector with PTC film produced as above was cut out into a round shape of 11.28 mm in diameter (area 1 cm²). Thereafter, an Al foil was lapped over the PTC film side of the current collector. The foil and current collector were sandwiched by cylindrical-shaped terminals having the same diameter and fixed in a jig. After that, the set value of the restrictive pressure to apply between the cylindrical-shaped terminals was changed to 15 MPa, 40 MPa, 64 MPa, and 96 MPa. The jig on which a restrictive pressure of each set value was applied was installed in a thermostatic bath. The electrical resistance when the temperature was increased to 220° C. at a fixed increase rate was measured. The maximum value of the obtained resistance was determined as the resistance when heated [Ω·cm²]. When the electrical resistance was measured, 1 mA of constant current conduction was made between the terminals, and the voltage between the terminals when the conduction was made was measured, whereby the resistance value was calculated. The results are shown in Table 2 and FIG. 5. The restrictive pressure [MPa] is taken along the horizontal axis and the resistance when heated [Ω·cm²] is taken along the vertical axis in FIG. 5.

TABLE 2

| Restrictive pressure [MPa] | Resistance when heated [Ω · cm²] |
|---|---|
| 15 | 8955 |
| 40 | 8527 |
| 64 | 92 |
| 96 | 12 |

As shown in Table 2 and FIG. 5, when the restrictive pressure was 15 MPa and 40 MPa, the resistance when heated was under 9000 Ω·cm². In contrast, when the restrictive pressure was 64 MPa, the resistance when heated rapidly decreased to under 100 Ω·cm². Further, when the restrictive pressure was increased to 96 MPa, the resistance when heated decreased to around 10 Ω·cm². It is considered this is because: when the value of the restrictive pressure was too high, the PTC film that could not endure the pressure collapsed, and was pushed out of the portion between the terminals; as a result, an electron conductive path was formed between the conductive materials in the PTC film, and the terminals had a direct contact with each other.

If a similar event occurs in an abuse examination of an actual all-solid-state battery, the PTC film is pushed out from the portion between the current collector and the active material layer. Thus, there is a possibility that the resistance increase of the PTC film gets insufficient even though the PTC film is arranged between the current collector and the active material layer. If the resistance increase of the PTC film is insufficient, the effect to stop the battery reaction when a short circuit occurs may be insufficient, therefore it might be difficult to inhibit the Joule heat accompanied by the short circuit. Thus, in view of making it easy to stop the battery reaction when a short circuit occurs, the restrictive pressure may be no more than 40 MPa.

### REFERENCES SIGN LIST

1 cathode layer
1a cathode current collector
1b cathode active material layer
2 anode layer
2a anode current collector
2b anode active material layer
3 solid electrolyte layer
4 PTC film
10 all-solid-state battery

1. An all-solid-state battery comprising:
a cathode layer including a cathode active material layer and a cathode current collector;
an anode layer including an anode active material layer and an anode current collector; and
a solid electrolyte layer arranged between the cathode active material layer and the anode active material layer,
wherein
a PTC film is provided:
between the cathode current collector and the cathode active material layer; or
between the anode current collector and the anode active material layer; or
between the cathode current collector and the cathode active material layer and between the anode current collector and the anode active material layer, and
the PTC film includes a conductive material and a resin.

2. The all-solid-state battery according to claim 1, wherein a restrictive pressure is added in a direction to make the cathode current collector and the anode current collector get close to each other, and the restrictive pressure is no more than 40 MPa.

3. The all-solid-state battery according to claim 2, wherein the restrictive pressure is no less than 0.8 MPa.

4. The all-solid-state battery according to claim 1, wherein the resin is a thermoplastic resin that melts at a temperature higher than 100° C.

5. The all-solid-state battery according to claim 4, wherein the resin is PVDF, polyethylene or polypropylene.

6. A method for manufacturing the all-solid-state battery according to claim 1, the method comprising: after the PTC film is formed, carrying out a heat treatment at a temperature of no less than 120° C. and no more than 165° C.

7. The all-solid-state battery according to claim 5, wherein the resin is PVDF whose molecular weight shows no less than 1.0×10⁵.
